(19) United States
(12) Patent Application Publication
(10) Pub. No.: US 2003/0085700 A1
(43) Pub. Date: May 8, 2003

(54) Magnetic displacement sensor device and method for detecting displacements

(76) Inventor: Shogo Momose, Nagano (JP)

Correspondence Address: HOGAN & HARTSON L.L.P., 500 S. GRAND AVENUE, SUITE 1900, LOS ANGELES, CA, 90071-2611, US

(21) Appl. No.: 10/281,396

(22) Filed: Oct. 24, 2002

(30) Foreign Application Priority Data
Oct. 26, 2001 (JP) 2001-329802

(51) Int. Cl. G01B 7/30; G01B 7/14

(52) U.S. Cl. 324/207.17; 324/207.18; 324/207.19; 324/207.25

(57) ABSTRACT

A magnetic displacement sensor device includes a plurality of magnetic displacement sensors, each of the magnetic displacement sensors having at least one coil wound thereon, and a single common excitation oscillator connected to each of the coils wound on the respective magnetic displacement sensors. Each of the coils are excited at the same oscillatory frequency and in the same phase by the single common excitation oscillator.

### BACKGROUND OF THE INVENTION

1. Field of the Invention

The present invention relates to magnetic displacement sensor devices, in which a plurality of magnetic displacement sensors are arranged and configured to detect their relative positions to detection subjects. The present invention also relates to a method for detecting displacements.

2. Description of Related Art

Generally, magnetic displacement sensors are widely used in various types of devices that identify the unevenness or the material of detection subjects, such as coins, in such devices as vending machines, ticket vending machines and ATMs, or in motor rotation drive control devices. Conventional magnetic displacement sensors are what are called eddy current type, such as shown in FIG. 11. A current is applied to a coil 2 wound around a core body 1, which is rod-shaped, to generate a magnetic flux φr for detection purposes. A metallic detection subject 3 and the core body 1 are moved relatively close to and far away from each other within a magnetic field formed by the detection magnetic flux φr. The magnetic resistance changes depending on changes in the size of the eddy current that is created in the detection subject 3 in relation to the changing distance between the detection subject 3 and the core body 1. By capturing the amount of change of the magnetic resistance as an amount of change in inductance, a detection output such as shown in FIG. 12 is obtained.

In actually using such a magnetic displacement sensor, two or more magnetic displacement sensors 10 are often arranged in close proximity to the detection subject 3, as shown in FIGS. 9 and 10. The distance between each of the magnetic displacement sensors 10 and the detection subject 3 is measured based on detection outputs from the plurality of the magnetic displacement sensors 10, and information such as the position, tilt and thickness of the detection subject 3 is detected based on such detection results.

However, in recent years, due to various reasons including a trend toward smaller devices, a plurality of magnetic displacement sensors is more frequently used in extremely close proximity to each other, such as in a rotation shaft control devices for magnetic levitation motors, for example. In such cases, magnetic fields generated by various magnetic displacement sensors cause mutual magnetic influences, which generate beat noise due to mutual interference between magnetic fields, and favorable detection operations cannot take place.

Some attempts that have been made in the past in order to prevent such interference between magnetic fields include placing magnetic shield members between adjacent magnetic displacement sensors in a plurality of magnetic displacement sensors, and setting the frequency of a drive circuit that drives each magnetic displacement sensor at a different value to remove with filters noise received from other magnetic fields. However, when magnetic shield members are used, the overall device size becomes larger due to the need to create space to accommodate the magnetic shield members, and the method still fails to completely prevent the interference phenomenon between the magnetic fields. When different drive frequencies are used for various magnetic displacement sensors, drive devices for different frequencies must be provided, which increases the cost and size of the overall device.

### SUMMARY OF THE INVENTION

In view of the above, the present invention provides magnetic displacement sensor devices that can yield stable detection results with good detection sensitivity through a simple configuration suited for small devices.

A magnetic displacement sensor device in accordance with an embodiment of the present invention includes a plurality of magnetic displacement sensors, each of the magnetic displacement sensors having a coil that is connected to one common excitation oscillator, so that each of the coils becomes excited at the same oscillatory frequency and in the same phase by the one common excitation oscillator.

In other words, in the magnetic displacement sensor device having such a configuration, mutual interference between magnetic fields of the plurality of magnetic displacement sensors becomes favorably prevented, due to the fact that every coil in the plurality of magnetic displacement sensors is excited at the same oscillatory frequency and in the same phase by the common excitation oscillator.

Further, in the magnetic displacement sensor device in accordance with the embodiment of the present invention, an excitation coil and a detection coil may be wound on each of the cores of the magnetic displacement sensors. Each of the excitation coils wound on the respective cores of the plurality of magnetic displacement sensors may be connected to a common excitation oscillator. In addition, in the magnetic displacement sensor device according to the present embodiment, either the excitation coil or the detection coil may have two coil sections to provide a differential output. Consequently, mutual interference between magnetic fields of the plurality of magnetic displacement sensors in so-called separately excited magnetic displacement sensors is favorably prevented.

In the magnetic displacement sensor device in accordance with the present embodiment, the plurality of magnetic displacement sensors may be installed on a rotation shaft of a motor, such that in a plane orthogonal to the axial direction at least two magnetic displacement sensors are placed to oppose the rotation shaft in the radial direction. Further, in the magnetic displacement sensor device in accordance with the present embodiment, the plurality of the magnetic displacement sensors may be installed on a rotation shaft of a motor, such that at least one of the magnetic displacement sensors is placed in the axial direction to oppose the rotation shaft in the axial direction. Consequently, mutual interference between magnetic fields of the plurality of magnetic displacement sensors in a motor using so-called separately excited magnetic displacement sensors is favorably prevented, and rotation properties of the motor are improved due to the fact that favorable rotation shaft control becomes possible.

In accordance with another embodiment of the present invention, a magnetic displacement sensor device includes a plurality of magnetic displacement sensors, each of the plurality of magnetic displacement sensors having an excitation coil that is connected to one common excitation oscillator, so that each of the excitation coils becomes excited at the same oscillatory frequency and in the same phase by the one common excitation oscillator.

In other words, in the magnetic displacement sensor device having such a configuration, mutual interference between magnetic fields of the plurality of magnetic displacement sensors becomes favorably prevented, due to the fact that every excitation coil in the plurality of magnetic displacement sensors is excited at the same oscillatory frequency and in the same phase by the common excitation oscillator.

In the magnetic displacement sensor device in accordance with the present embodiment, a detection subject may be a shaft body, and the plurality of magnetic displacement sensors is placed separated from each other in the circumferential direction and around the shaft body. As a result, information such as the position of the shaft body can be favorably obtained through the plurality of magnetic displacement sensors without any mutual interference between magnetic fields.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 shows a side view of a summary structure of a displacement sensor in one embodiment of the present invention.

FIG. 2 shows an exterior perspective view of a core structure of the displacement sensor shown in FIG. 1.

FIG. 3 shows a circuit diagram indicating one example of a drive circuit provided on a magnetic displacement sensor.

FIG. 4 shows a circuit diagram illustrating a summary of a drive circuit provided on a magnetic displacement sensor in accordance with one embodiment of the present invention.

FIG. 5 shows a side view illustrating relative positions of two magnetic displacement sensors when the interference between the two magnetic displacement sensors used in close proximity is measured.

FIG. 6 is a line graph indicating interference amplitudes of magnetic displacement sensors measured at positions shown in FIG. 5.

FIG. 7 shows a circuit diagram illustrating another example of a drive circuit provided on a magnetic displacement sensor.

FIG. 8 shows a circuit diagram illustrating a summary of a drive circuit provided on a magnetic displacement sensor in another embodiment of the present invention.

FIG. 9 shows a plan view illustrating one example of relative positions of magnetic displacement sensors to a detection subject.

FIG. 10 shows a plan view illustrating another example of relative positions of magnetic displacement sensors to a detection subject.

FIG. 11 shows a side view illustrating an overall structure of a general displacement sensor.

FIG. 12 shows a line graph of a detection output by the general displacement sensor shown in FIG. 11.

### DESCRIPTION OF PREFERRED EMBODIMENTS

Embodiments of the present invention are described below in detail with reference to the accompanying drawings.

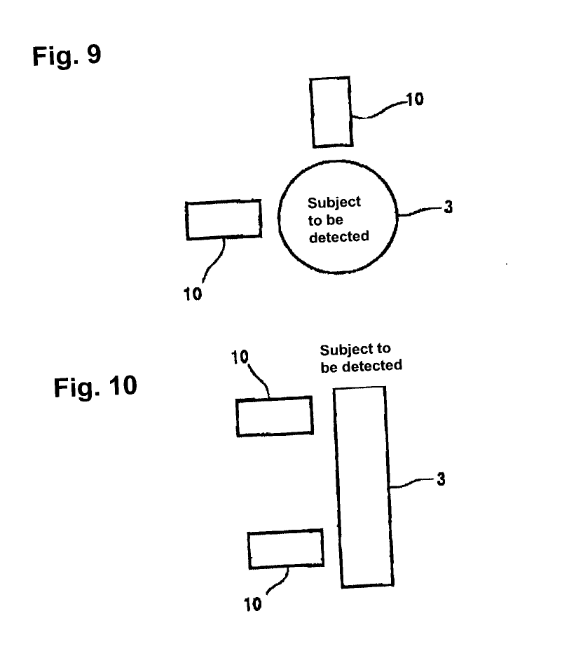

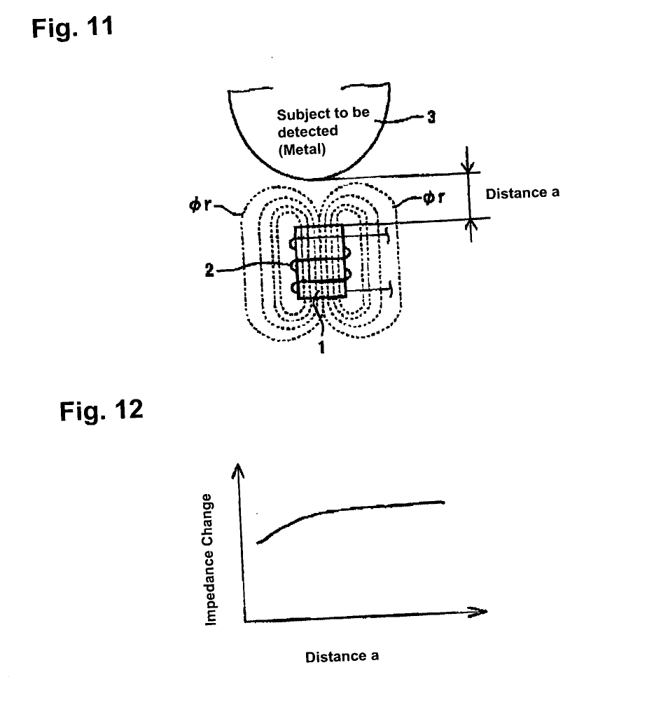

A magnetic displacement sensor device in accordance with an embodiment of the present invention includes a plurality of separately excited magnetic displacement sensors 10 that are placed in close proximity to a detection subject 3, as shown in FIGS. 9 and 10 described above. The distance between each of the magnetic displacement sensors 10 and the detection subject 3 is measured based on a detection output from each of the plurality of the magnetic displacement sensors 10, and information such as the position, tilt and thickness of the detection subject 3 is obtained based on such measurement results. To describe the structure of such a magnetic displacement sensor device, the structure of one of the magnetic displacement sensors 10 itself will be described first.

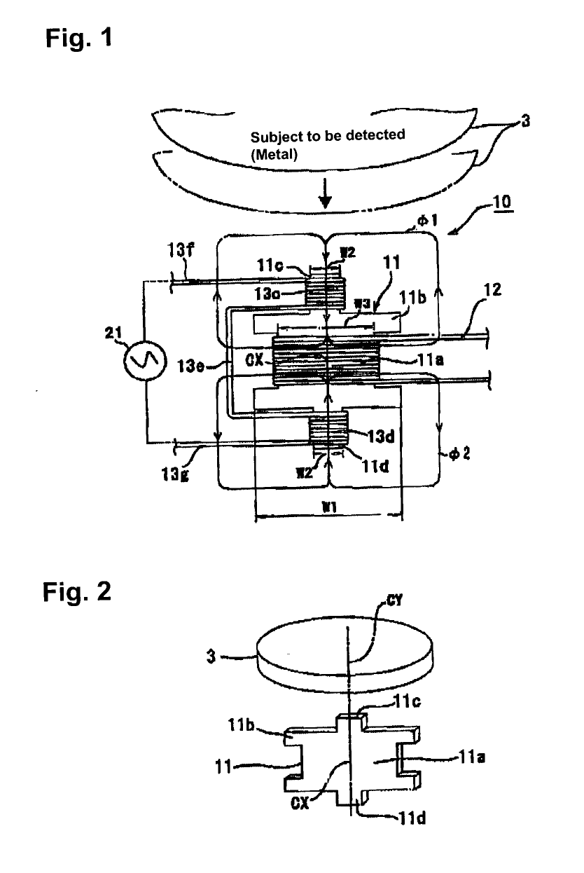

In the so-called separately excited magnetic displacement sensor 10 according to the present invention and as shown in FIGS. 1 and 2, a detection coil 12 is wound around a center core section 11a of a core body 11 that may be composed of a single thin plate-shaped member, and excitation coils 13c and 13d are wound around a pair of shaft end core sections 11c and 11d, respectively. The shaft end core sections 11c and 11d are connected in a unitary fashion via retaining flange sections 11b, each of which is placed at the top and bottom sides of the center core section 11a.

Of the pair of the shaft end core sections 11c and 11d, the shaft end core section 11c at the top in the figure is positioned to oppose the detection subject 3 that may be composed of a metallic member or a magnetic substance. In the meantime, a shaft center CX (in a vertical direction in the figure) that runs from the shaft end core section 11c, through the center core section 11a, to the shaft end core section 11d on the opposite side is positioned to virtually coincide with a shaft center CY of the detection subject 3. With this configuration, the detection subject 3 is moved back and forth along the direction of the shaft center CX relative to the shaft end core section 11c, and the position of the detection subject 3 is detected when the shaft end core section 11c and the detection subject 3 move close to and away from each other as they oppose each other. The magnetic displacement sensor 10 may be configured such that the magnetic displacement sensor 10 is moved while the detection subject 3 remains fixed.

More specifically, the center core section 11a is placed generally in the center section of the magnetic displacement sensor 10 in the direction in which the shaft center CX extends (i.e., in the vertical direction), and a width dimension W₁ of the retaining flange sections 11b in the direction orthogonal to the direction of the shaft center CX (i.e., in the horizontal direction) is formed relatively widely. In contrast, a width dimension W₂ of each of the shaft end core sections 11c and 11d is smaller than the width dimension W₁ of the retaining flange sections 11b (W₂<W₁). In the present embodiment, each of the widths W₂ is formed to be one-half or less of the width dimension W₁ (W₂≦W₁/2). The part of the center core section 11a around which the detection coil 12 is wound is notched to a slightly smaller width dimension W₃ compared to the width W₁ of the retaining flange sections 11b.

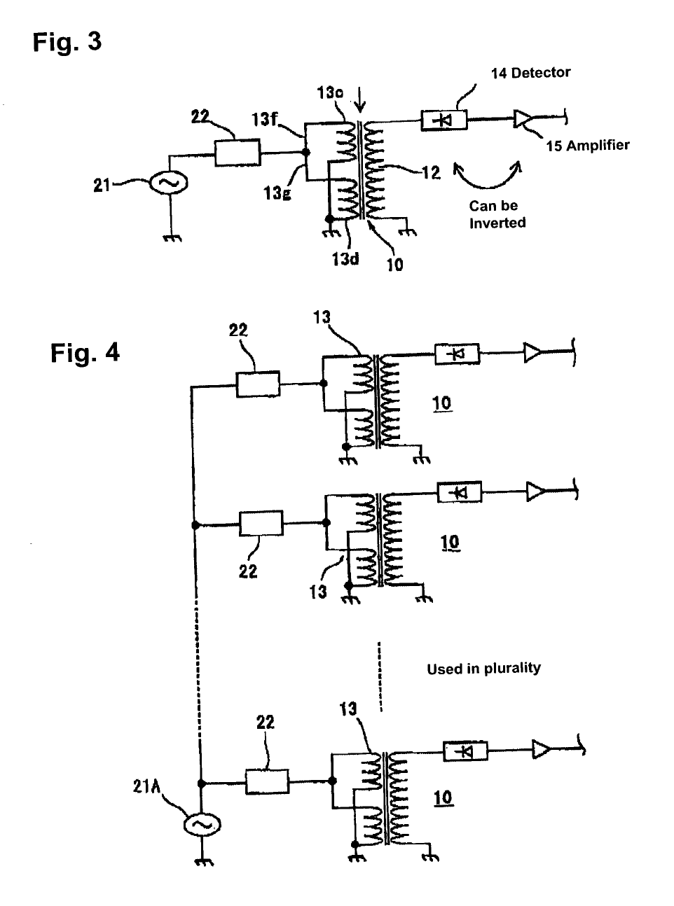

As shown in FIG. 3, the pair of excitation coils 13c and 13d wound around the shaft end core sections 11c and 11d, respectively, comprises a series of coil members connected in a unitary fashion. Of the coil members, the inner end parts that are wound around the base parts of the shaft end core sections 11c and 11d are connected in a unitary fashion in series by a crossover 13e.

In the meantime, lead sections 13f and 13g that are led out from outer ends of the shaft end core sections 11c and 11d, respectively, are both connected to an excitation oscillator 21, which uses a crystal, via a drive amplifier 22. When a sine wave or a square wave generated by the excitation oscillator 21 is applied to a coil winding section of each of the shaft end core sections 11c and 11d, opposing magnetic fields φ1 and φ2 are formed in opposite directions on the same shaft center CX.

Each of the retaining flange sections 11b and 11b, which is provided at a boundary section between the center core section 11a and one of the pair of shaft end core sections 11c and 11d, is in an overhang shape that protrudes in the width direction that is generally orthogonal to the direction of the shaft center CX, and one of the excitation coils 13c and 13d is wound around at the top and bottom in the shaft center direction relative to one of the locking retaining sections 11b. In other words, the winding position of each of the excitation coils 13c and 13d is determined by the retaining flange sections 11b and 11b.

Further, as shown especially in FIG. 3, an output side part of the detection coil 12 is connected to an amplifier 15 via a detector 14, and a final detection signal is obtained through the amplifier 15. The detection signal that is output from the detection coil 12 in the magnetic displacement sensor 10 is based on a magnetic field equivalent to the sum of the opposing magnetic fields φ1 and φ2 in opposite directions that are generated by the pair of excitation coils 13c and 13d. Consequently, if the detection subject 3 does not exist, or if the detection subject 3 is sufficiently far away (at an infinite distance) from the magnetic displacement sensor 10, the absolute values of the opposing magnetic fields φ1 and φ2 in opposite directions become equal (|φ1|=|φ2|), and the output from the detection coil 12 becomes zero. On the other hand, if the magnetic displacement sensor 10 and the detection subject 3 become relatively close to each other, an eddy current that is generated in the detection subject 3 changes in relation to the change in the distance between them, and the change in the eddy current causes the opposing magnetic fields φ1 and φ2 in opposite directions to be imbalanced. For example, when φ1 becomes large, φ2 becomes small. And a differential output can be obtained from the detection coil 12 based on a magnetic field equivalent to the difference between the absolute values of the opposing magnetic fields φ1 and φ2 (|φ1|−|φ2|) in such a situation.

An output can be obtained from such a differential state, and the output can be expressed by the following equation, for example:

Equation 1:

$$Output = \frac{ⅆ {φ}_{1}}{ⅆ t} - \frac{ⅆ {φ}_{2}}{ⅆ t}$$

Where,

φ₁=A sin ωt (φ₁ and φ₂ are in the same phase)

φ₂=B sin ωt

In other words, in the magnetic displacement sensor 10 having a configuration described above, the excitation coils 13c and 13d and the detection coil 12 are placed differentiated from each other and detection takes place based on the balance between the pair of excitation coils 13c and 13d. Consequently, the amount of change in magnetic flux can be obtained with favorable linearity and at high sensitivity using a thin and small core body 11, regardless of impedance due to direct current resistance. Furthermore, stable detection operations are possible using an inexpensive circuit without having to use constant-current circuits as in the past, regardless of fluctuations in ambient temperature.

Moreover, in the present embodiment, current efficiency in the shaft end core sections 11c and 11d, which come into close proximity with the detection subject 3, is improved by setting a small width for the shaft end core sections 11c and 11d. This generates more magnetic flux, so that the amount of change in detection, i.e., the sensitivity, is further enhanced. In addition, in the magnetic displacement sensor 10 according to the present embodiment, due to the fact that the winding position of each of the coils 12, 13c and 13d can be determined with high precision by providing the retaining flange section 11b at the boundary parts between the center core section 11a and each of the shaft end core sections 11c and 11d, phase displacements and output displacements are reduced while large change rates can be obtained. Moreover, in the magnetic displacement sensor 10 according to the present embodiment, due to the fact that the output balance between the pair of excitation coils 13c and 13d is given as a differential state, an accurate detection with even higher sensitivity becomes possible. Further, since the sensor 10 provides differential outputs, the sensor 10 shows good thermal properties.

It is noted that a plurality of separately excited magnetic displacement sensors 10 each having the structure described above may be used (see FIGS. 9 and 10 ). Each of the drive amplifiers 22, to which the excitation coils 13c and 13d of each of the corresponding magnetic displacement sensors 10 in the present embodiment are connected, is connected to a single excitation oscillator 21A in a shared state, as shown in FIG. 4. In other words, a sine wave or a square wave at the same oscillatory frequency and in the same phase is output and provided from the single common excitation oscillator 21A to all of the excitation coils 13c and 13d, and the sine wave or the square wave at the same oscillatory frequency and in the same phase excites the excitation coils 13c and 13d in each of the magnetic displacement sensors 10.

In the so-called separately excited magnetic displacement sensor device according to the present embodiment, due to the fact that the excitation coils 13c and 13d of each magnetic displacement sensor 10 become excited at the same oscillatory frequency and in the same phase by the common excitation oscillator 21A, mutual interference by magnetic fields of the plurality of magnetic displacement sensors 10 is nearly completely prevented.

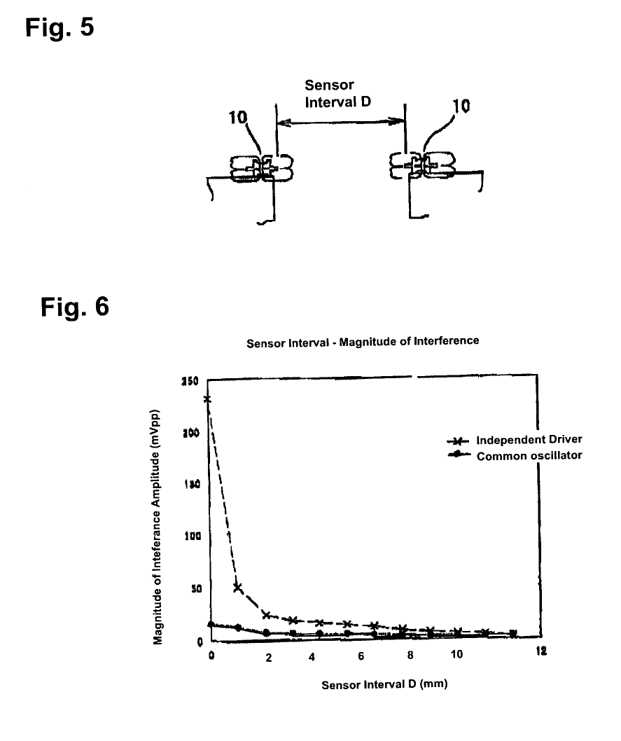

For example, when a pair of magnetic displacement sensors 10 and 10 were placed separated by an interval D as shown in FIG. 5 and interference between the two magnetic displacement sensors 10 and 10 were measured, the results were as indicated in FIG. 6. As FIG. 6 shows, when the size of interference amplitude (y-axis in FIG. 6) generated by the mutual interference between the magnetic displacement sensors 10 and 10 was measured in relation to the sensor interval D (x-axis in FIG. 6), it was found that the interference amplitude (indicated by a solid line) in a device according to the present invention in which a common excitation oscillator 21A was provided to the pair of magnetic displacement sensors 10 and 10 was greatly reduced compared to the interference amplitude (indicated by a broken line) in a conventional device in which an excitation oscillator 21 was provided for each magnetic displacement sensor 10.

It was found that the reduction effect in interference amplitude when the pair of magnetic displacement sensors 10 and 10 was brought into a close proximity to each other was especially significant. For example, in a conventional device even when the pair of magnetic displacement sensors 10 and 10 were separated by approximately 10 mm, an interference amplitude of approximately 5 mVpp was generated, which exceeded a standard value (for example, 3.2 mVpp) of allowable interference amplitude. In contrast, in a device according to the present embodiment, even when the pair of magnetic displacement sensors 10 and 10 was brought close together to a distance of approximately 6 mm, the interference amplitude was within the allowable standard value (for example, 3.2 mVpp).

The magnetic displacement sensor device according to the present invention in which there is hardly any mutual interference between magnetic fields can be extremely favorably used in magnetic levitation motors, for example. Typically a magnetic levitation motor has a structure in which a plurality of magnetic displacement sensors detects at high precision and controls the displacement and tilt of a rotation shaft. In the magnetic levitation motor, in a plane orthogonal to the rotation shaft of the motor, at least two magnetic displacement sensors are placed to oppose in the radial direction the rotation shaft, and at least one magnetic displacement sensor is placed in the axial direction to oppose in the axial direction the rotation shaft. With such a structure of the magnetic levitation motor, the plurality of magnetic displacement sensors is placed in extremely close proximity to one another. Consequently, by utilizing in magnetic levitation motors a magnetic displacement sensor device according to the present invention that hardly generates any mutual interference, favorable rotation shaft control becomes possible and the motor's rotation properties can be improved.

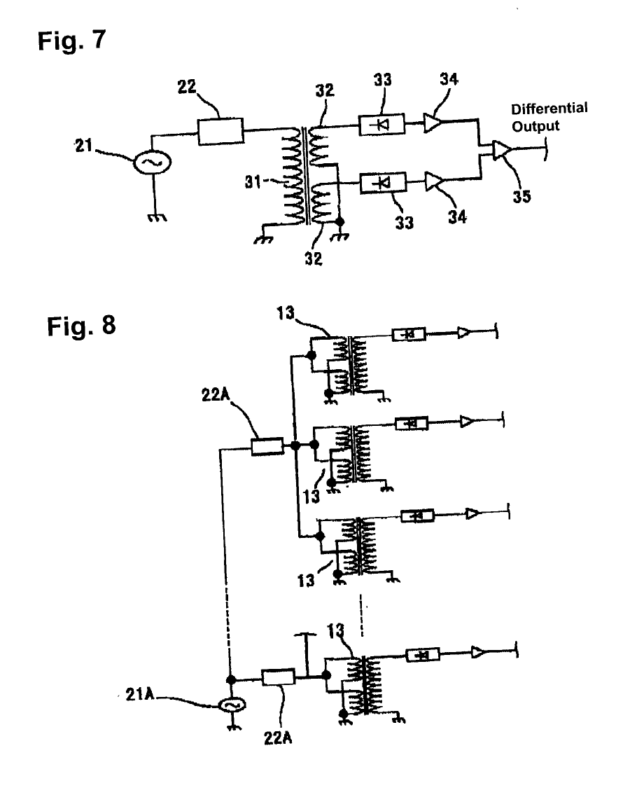

Further, although in the present embodiment, each of the excitation coils 13c and 13d is placed on either side of the detection coil 12, in other words, the detection coil 12 is placed between the two detection coils 13c and 13d, the present invention is equally applicable to a magnetic displacement sensor having a structure in which the placement of excitation coils and detection coils are reversed, as shown in FIG. 7. For example, a detection coil 32 can be placed at either side of an excitation coil 31, which is placed between the two detection coils 32. In this case, a detector 33 and an amplifier 34 is connected to each of the detection coils 32, and a detection signal of each detection coil 32 is input into a differential amplifier 35 to obtain a differential output.

In an embodiment shown in FIG. 8, in addition to an excitation oscillator 21A that is shared as in an earlier embodiment, a drive amplifier 22A is also shared as much as its capacity allows. For example, three excitation coils 13 can be driven by each drive amplifier 22A.

Various embodiments of the present invention by the inventor have been described above in detail, but the present invention is not limited to the embodiments described above and many modifications can be made without departing from the present invention.

For example, in an embodiment described above, the width dimension of the shaft end of core section 11c is smaller than the width dimension of the center core section 11a (W₂<W₁), but the two dimensions may be equal or their size relations may be reversed. In addition, a concave notched section is provided in a part of the center core section 11a of the core body 11 in an embodiment described above where the detection coil 12 is wound around, but the center core section can be formed as a simple rectangular shape and without such a notched section.

In an embodiment described above, a single thin plate-shaped member is used as the core body 11, but a three-dimensional core body can also be used. In this case, the center part in the axial direction can be a simple shape without any notched concave sections.

Although the pair of excitation coils 13c and 13d is connected serially in a unitary fashion in an embodiment described above, the excitation coils 13c and 13d may be connected in parallel to form opposing magnetic fields.

As described above, in a magnetic displacement sensor device according to the present invention, each coil in a plurality of magnetic displacement sensors is connected to one common excitation oscillator, so that each of the coils becomes excited at the same oscillatory frequency and in the same phase by the one common excitation oscillator. In this way, mutual interference between magnetic fields of the plurality of magnetic displacement sensors is favorably prevented. Consequently, stable detection results can be obtained while also obtaining favorable detection sensitivity with a simple configuration suited for small devices, and reliability and usefulness of the magnetic displacement sensor device can be realized inexpensively.

Further, in a magnetic displacement sensor device according to the present invention, an excitation coil and a detection coil are wound around a core of each of a plurality of magnetic displacement sensors, and each excitation coil wound around the core of one of the plurality of magnetic displacement sensors is connected to a common excitation oscillator. In addition, in the magnetic displacement sensor device according to the present invention, either the excitation coil or the detection coil has two coil sections to provide a differential output. Consequently, mutual interference between magnetic fields of the plurality of magnetic displacement sensors in so-called separately excited magnetic displacement sensors is favorably prevented. As a result, reliability and usefulness of the separately excited magnetic displacement sensor device can be realized inexpensively.

In a magnetic displacement sensor device according to the present invention, a plurality of magnetic displacement sensors is installed on a rotation shaft of a motor, such that at least two magnetic displacement sensors are placed in a plane orthogonal to the axial direction. Further, in the magnetic displacement sensor device according to the present invention, the plurality of the magnetic displacement sensors is installed on the rotation shaft of the motor, such that at least one magnetic displacement sensor is placed in the axial direction. Consequently, mutual interference between magnetic fields of the plurality of magnetic displacement sensors in motors using so-called separately excited magnetic displacement sensors is favorably prevented, rotation properties of the motors are improved, and the motor's performance can be improved while the motor is made more compact.

In the meantime, in a magnetic displacement sensor device according to the present invention, each excitation coil in a plurality of magnetic displacement sensors is connected to one common excitation oscillator, so that each of the excitation coils becomes excited at the same oscillatory frequency and in the same phase by the one common excitation oscillator, thereby favorably preventing mutual interference between magnetic fields of the plurality of magnetic displacement sensors. Consequently, stable detection results can be obtained while also obtaining favorable detection sensitivity with a simple configuration suited for small devices, and reliability and usefulness of the magnetic displacement sensor device can be realized inexpensively.

In a magnetic displacement sensor device according to the present invention, a detection subject comprises a shaft body, and a plurality of magnetic displacement sensors is placed separated from each other in the circumferential direction and around the shaft body. As a result, information such as the position of the shaft body can be favorably obtained through the plurality of magnetic displacement sensors without any mutual interference between magnetic fields, so that, in addition to the effects described above, the shaft body in particular can be accurately controlled.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A magnetic displacement sensor device comprising:
a plurality of magnetic displacement sensors, each of the magnetic displacement sensors having at least one coil wound thereon; and
a single common excitation oscillator connected to each of the coils wound on the respective magnetic displacement sensors, wherein each of the coils becomes excited at the same oscillatory frequency and in the same phase by the single common excitation oscillator.

2. A magnetic displacement sensor device according to claim 1, wherein the at least one coil includes an excitation coil and a detection coil wound on each of the respective cores of the plurality of magnetic displacement sensors, and each of the excitation coils wound on the respective cores of the plurality of magnetic displacement sensors is connected to the common excitation oscillator.

3. A magnetic displacement sensor device according to claim 2, wherein one of the excitation coil and the detection coil has two coil sections to provide a differential output.

4. A magnetic displacement sensor device according to claim 2, wherein the plurality of magnetic displacement sensors are installed on a rotation shaft of a motor, wherein at least two of the magnetic displacement sensors are placed in a plane orthogonal to the axial direction to oppose the rotation shaft in the radial direction.

5. A magnetic displacement sensor device according to claim 2, wherein at least one of the magnetic displacement sensors is placed in the axial direction to oppose the rotation shaft in the axial direction.

6. A magnetic displacement sensor device comprising:
a plurality of magnetic displacement sensors, each of the plurality of magnetic displacement sensors having an excitation coil; and
a single excitation oscillator commonly connected to each of the excitation coils, wherein each of the excitation coils becomes excited at the same oscillatory frequency and in the same phase by the single excitation oscillator.

7. A magnetic displacement sensor device according to claim 6, wherein the plurality of magnetic displacement sensors is placed separated from each other in a circumferential direction of a shaft body.

8. A magnetic displacement sensor device according to claim 1, wherein each of the plurality of magnetic displacement sensors comprises a core body including a center core section having a first width in a direction orthogonal to a center shaft of the core body, a detection coil wound around the center core section, a pair of end core sections each having a second width in the direction orthogonal to the center shaft of the core body narrower than the first width, and a pair of excitation coils wound on the respective end core sections.

9. A magnetic displacement sensor device according to claim 8, wherein the core body further includes a pair of flange sections, each of the flange sections being provided between the center core section and either of the end core sections, wherein each of the flange sections has a third width in the direction orthogonal to the center shaft of the core body wider than the first width of the center core section.

10. A magnetic displacement sensor device according to claim 9, wherein the second width of each of the end core sections is smaller than the third width of each of the flange sections.

11. A magnetic displacement sensor device according to claim 10, wherein the second width of each of the end core sections is generally half or smaller than the third width of each of the flange sections.

12. A magnetic displacement sensor device according to claim 8, wherein the pair of excitation coils wound on the respective end core sections are connected in series to each other.

13. A magnetic displacement sensor device according to claim 12, wherein the pair of excitation coils are commonly connected to the single common excitation oscillator.

14. A magnetic displacement sensor device according to claim 13, wherein the pair of excitation coils generate opposing magnetic fields in opposite directions on the center shaft, and the detection coil provides a differential output corresponding to an absolute difference between the opposing magnetic fields.

15. A magnetic displacement sensor device according to claim 1, wherein each of the plurality of magnetic displacement sensors comprises a detection coil and a pair of excitation coils, each of the excitation coils being placed adjacent to either end of the detection coil.

16. A magnetic displacement sensor device according to claim 15, wherein the pair of excitation coils are connected in series to each other.

17. A magnetic displacement sensor device according to claim 16, wherein the pair of excitation coils are commonly connected to the single common excitation oscillator.

18. A magnetic displacement sensor device according to claim 17, wherein the pair of excitation coils generate opposing magnetic fields in opposite directions on a common axis, and the detection coil provides a differential output corresponding to an absolute difference between the opposing magnetic fields.

19. A method for detecting displacements of a subject, the method comprising the steps of:
placing at least one magnetic displacement sensor having a detection coil and a pair of excitation coils, each of the excitation coils being placed adjacent to either end of the detection coil, adjacent to the subject;
exciting by a single excitation oscillator the excitation coils commonly connected to the single excitation oscillator at the same oscillatory frequency and in the same phase by the single excitation oscillator.

20. A method for detecting displacements of a subject according to claim 19, wherein the pair of excitation coils generate opposing magnetic fields in opposite directions on a common axis, and the detection coil provides a differential output corresponding to an absolute difference between the opposing magnetic fields.
